(19) United States
(12) Patent Application Publication
(10) Pub. No.: US 2015/0116508 A1
(43) Pub. Date: Apr. 30, 2015

(54) INFORMATION PROCESSING APPARATUS, IMAGING APPARATUS, IMAGING SYSTEM, METHOD OF CONTROLLING INFORMATION PROCESSING APPARATUS, METHOD OF CONTROLLING IMAGING APPARATUS, AND PROGRAM

(71) Applicant: Sony Corporation, Tokyo (JP)

(72) Inventors: Ryogo Ito, Tokyo (JP); Shiro Eshita, Tokyo (JP); Megumi Takagi, Kanagawa (JP); Ayumi Yamamoto, Tokyo (JP); Kazuma Akamatsu, Tokyo (JP)

(21) Appl. No.: 14/488,336

(22) Filed: Sep. 17, 2014

(30) Foreign Application Priority Data
Oct. 29, 2013 (JP) 2013-224256

(51) Int. Cl. H04N 1/00; H04W 4/00

(52) U.S. Cl. CPC H04N 1/00204; H04W 4/008; H04N 2201/0084
USPC 348/207.1

(57) ABSTRACT

Provided is an information processing apparatus including: a wireless communication unit that performs communication between the information processing apparatus and an imaging apparatus using short-range wireless communication; and a control unit that determines whether or not the imaging apparatus is mounted, based on a result of the communication with the imaging apparatus that uses the short-range wireless communication.

### CROSS REFERENCE TO RELATED APPLICATIONS

This application claims the benefit of Japanese Priority Patent Application JP 2013-224256 filed Oct. 29, 2013, the entire contents of which are incorporated herein by reference.

### BACKGROUND

The present technology relates an information processing apparatus and an imaging apparatus, and more particularly to an information processing apparatus and an imaging apparatus, each of which performs wireless communication with a different apparatus, an imaging system, a method of controlling the information processing apparatus, a method of controlling the imaging apparatus, a method of controlling the imaging system, a program for causing a computer to execute the method of controlling the information processing apparatus, a program for causing a computer to execute the method of controlling the imaging apparatus, and a program for causing a computer to execute the method of controlling the imaging system.

Digital still cameras or digital video cameras (for example, a camera-integrated recorder) that generate an image (image data) by imaging a photographic subject and record the image as content have been in wide use in the related art. Furthermore, wireless communication technologies are available that exchanges various items of data using wireless communication.

Furthermore, technologies are available that operate the imaging apparatus with a different apparatus using wireless communication. For example, an electronic apparatus has been proposed that, when a contact operation on an operation switch image that is displayed on a display unit is detected, causes the imaging apparatus to execute an operation corresponding to the operation switch image on which the contact operation is performed (for example, refer to Japanese Unexamined Patent Application Publication No. 2009-94591).

### SUMMARY

In the technology in the related art, described above, because the imaging apparatus can be operated with the electronic apparatus using the wireless communication, for example, even though the imaging apparatus and the electronic apparatus are positioned away from each other, the imaging apparatus can be operated with the electronic apparatus.

At this point, for example, it is assumed that an imaging apparatus is mounted on an image processing apparatus that can operate the imaging apparatus using wireless communication, and thus an imaging operation is performed. It is assumed that in terms of a state where the imaging apparatus and the information processing apparatus are used, this case is different from a case where the imaging apparatus is positioned away at a distance. For example, if the imaging operation is performed with the imaging apparatus and the information processing apparatus, it is important to suitably determine whether or not the imaging apparatus is mounted on the image processing apparatus and provide a user interface that is suitable according to whether or not the imaging apparatus is mounted. Furthermore, for example, if the information processing apparatus can operate a different apparatus using the wireless communication, it is important to suitably determine whether or not the different apparatus is mounted, in the same manner.

It is desirable to suitably determine whether an apparatus is mounted.

According to an embodiment of the present technology, there are provided an information processing apparatus, a method of controlling the information processing apparatus, and a program for causing a computer to execute the method, the information processing apparatus including a wireless communication unit that performs communication between the information processing apparatus and an imaging apparatus using short-range wireless communication; and a control unit that determines whether or not the imaging apparatus is mounted, based on a result of the communication with the imaging apparatus that uses the short-range wireless communication. Accordingly, an operation is brought about in which, based on a result of the communication with the imaging apparatus that uses the short-range wireless communication, it is determined whether or not the imaging apparatus is mounted.

In the image processing apparatus, the control unit may transmit a command for polling, if a response to the command is received, the control unit may determine that the imaging apparatus is mounted, and if the response to the command is not received, the control unit may determine that the imaging apparatus is not mounted. Accordingly, an operation is brought about in which if the command for polling is transmitted, and the response to the command is received, it is determined that the imaging apparatus is mounted, and if the response to the command is not received, it is determined that the imaging apparatus is not mounted.

In the image processing apparatus, if the response to the command is received, the control unit may transmit a check command for reading information relating to the imaging apparatus, and only if specific information for specifying the imaging apparatus is included in the response to the check command, the control unit may determine that the imaging apparatus is mounted. Accordingly, an operation is brought about in which if the response to the command for polling is received, the check command is transmitted, and only if the specific information is included in the response to the check command, it is determined that the imaging apparatus is mounted.

In the information processing apparatus, the wireless communication unit may perform the communication between the information processing apparatus and the imaging apparatus using near field communication (NFC) as the short-range wireless communication, and only if a polling response is received as the response to the transmitted polling command, the control unit may determine that the imaging apparatus is mounted, and if the response to the polling command is not received, the control unit may determine that the imaging apparatus is not mounted. Accordingly, an operation is brought about in which if the polling response is received as the response to the transmitted polling command, it is determined that the imaging apparatus is mounted, and if the response to the polling command is not received, it is determined that the imaging apparatus is not mounted.

In the information processing apparatus, if the polling response is received, the control unit may transmit a check command, and only if specific information for specifying the imaging apparatus is included in a check response that is received as a response to the check command, the control unit may determine that the imaging apparatus is mounted. Accordingly, an operation is brought about in which if the polling response is received, the check command is transmitted, and only if the specific information is included in the check response that is received as the response to the check command, it is determined that the imaging apparatus is mounted.

According to another embodiment, there are provided an imaging apparatus, a method of controlling the imaging apparatus, and a program for causing a computer to execute the method, the imaging apparatus including: a wireless communication unit that performs communication with the imaging apparatus and an information processing apparatus using short-range wireless communication; and a control unit that performs control relating to an imaging operation based on an operation input that is performed in the information processing apparatus that determines whether or not the imaging apparatus is mounted on the information processing apparatus based on a result of the communication between the imaging apparatus and the information processing apparatus that uses the short-range wireless communication. Accordingly, an operation is brought about in which the control relating to the imaging operation is performed based on the input operation that is performed in the information processing apparatus that determines whether the imaging apparatus is mounted on the information processing apparatus, based on the result of the communication between the imaging apparatus and the information processing apparatus that uses the short-range wireless communication.

In the imaging apparatus, if a command for polling is received from the information processing apparatus, the control unit may transmit a response to the command, and if the response to the command is received, the information processing apparatus may determine that the imaging apparatus is mounted, and if the response to the command is not present, the information processing apparatus may determine that the imaging apparatus is not mounted. Accordingly, an operation is brought about in which if the command for polling is received from the information processing apparatus, the response to the command is transmitted and if the response to the command is received, the information processing apparatus determines that the imaging apparatus is mounted, and if the response to the command is not present, the information processing apparatus determines that the imaging apparatus is not mounted.

In the imaging apparatus, the control unit may include specific information for specifying the imaging apparatus in a response to a check command for reading information relating to the imaging apparatus and thus may transmit the response, and if the response to the command is received, the information processing apparatus may transmit the check command, and only if the specific information is included in the response to the check command, the information processing apparatus may determine that the imaging apparatus is mounted. Accordingly, an operation is brought about in which the specific information is included in the response to the check command and thus the response including the specific information is transmitted, and if the response to the command is received, the information processing apparatus transmits the check command, and only if the specific information is included in the response to the check command, the information processing apparatus determines that the imaging apparatus is mounted.

In the imaging apparatus, the control unit may transmit a polling response as a response to a polling command that is transmitted by the information processing apparatus using NFC as the short-range wireless communication, and if the polling response is received as the response to the polling command, the information processing apparatus may determine that the imaging apparatus is mounted, and if the response to the polling command is not present, the information processing apparatus may determine that the imaging apparatus is not mounted. Accordingly, an operation is brought about in which the polling response is transmitted as the response to the polling command that is transmitted by the information processing apparatus using the NFC, and if the polling response is received as the response to the polling command, the information processing apparatus determines that the imaging apparatus is mounted, and if the response to the polling command is not present, the information processing apparatus determines that the imaging apparatus is not mounted.

In the imaging apparatus, the control unit may include specific information for specifying the imaging apparatus in a check response that is a response to a check command that is transmitted by the information processing apparatus and thus may transmit the check response, and if the polling response is received, the information processing apparatus may transmit the check command, and only if the specific information is included in the check response that is received as the response to the check command, the information processing apparatus may determine that the imaging apparatus is mounted. Accordingly, an operation is brought about in which the specific information is included in the response (check response) to the check command that is transmitted by the information processing apparatus and the check response is transmitted, and if the polling response is received, the information processing apparatus transmits the check command, and only if the specific information is included in the check response that is received as the response to the check command, the information processing apparatus determines that the imaging e apparatus is mounted.

According to a further embodiment of the present technology, there are provided an information processing apparatus, a method of controlling the information processing apparatus, and a program for causing a computer to execute the method, the information processing apparatus including a wireless communication unit that performs communication between the information processing apparatus and a different information apparatus using short-range wireless communication; and a control unit that determines whether or not the different image processing apparatus is mounted, based on a result of the communication with the different image processing apparatus that uses the short-range wireless communication. Accordingly, an operation is brought about in which it is determined whether or not the different information processing apparatus is mounted, based on the result of the communication with the different information processing apparatus that uses the short-range wireless communication.

According to a still further embodiment of the present technology, there are provided an imaging system, a method of controlling the system, and a program for causing a computer to execute the method, the imaging system including: an imaging apparatus that performs communication between the imaging apparatus and an information processing apparatus using short-range wireless communication; and an information processing apparatus that determines whether or not the imaging apparatus is mounted, based on a result of the communication with the imaging apparatus that uses the short-range wireless communication. Accordingly, an operation is brought about in which the imaging apparatus performs the communication between the imaging apparatus and the information processing apparatus using the short-range wireless communication, and the information processing apparatus determines whether or not the imaging apparatus is mounted, based on the result of the communication with the imaging apparatus that uses the short-range wireless communication.

With the present technology, an excellent effect is accomplished in which it can be suitably determined whether or not an apparatus is mounted. Moreover, limitation to this effect is not imposed, and any effects that are described in the present disclosure may be possible.

### BRIEF DESCRIPTION OF THE DRAWINGS

FIGS. 1A and 1B are views illustrating an external appearance of an imaging apparatus according to a first embodiment of the present technology;

FIGS. 2A and 2B are views illustrating an external configuration in which the imaging apparatus according to the first embodiment of the present technology is mounted on an information processing apparatus;

FIG. 3 is a block diagram illustrating an example of a functional configuration of the imaging apparatus according to the first embodiment of the present technology and of the information processing apparatus;

FIGS. 4A and 4B are views illustrating an example in which the imaging apparatus according to the first embodiment of the present technology and the information processing apparatus are used;

FIG. 5 is a sequence chart illustrating an example of communication processing between the imaging apparatus according to the first embodiment of the present technology and the information processing apparatus;

FIG. 6 is a flow chart illustrating, as one example, processing steps of mounting-detection processing by the information processing apparatus according to the first embodiment of the present technology;

FIG. 7 is a view illustrating an example in which a display screen that is displayed on an input and output unit according to the first embodiment of the present technology is switched;

FIGS. 8A to 8B are views illustrating an example in which the display screen that is displayed on the input and output unit according to the first embodiment of the present technology is displayed;

FIGS. 9A and 9B are views illustrating an example in which the display screen which is displayed on the input and output unit according to the first embodiment of the present technology is displayed;

FIGS. 10A and 10B are views illustrating an example in which the display screen which is displayed on the input and output unit according to the first embodiment of the present technology is displayed;

FIG. 11 is a flow chart illustrating, as one example, processing steps of display control processing by the information processing apparatus according to the first embodiment of the present technology;

FIG. 12 is a sequence chart illustrating an example of the communication processing between an imaging apparatus according to a second embodiment of the present technology and the information processing apparatus;

FIG. 13 is a flow chart illustrating, as one example, processing steps of the mounting-detection processing by an information processing apparatus according to the second embodiment of the present technology; and

FIG. 14 is a view illustrating a content example of a NDEF that is exchanged between the imaging apparatus according to the second embodiment of the present technology and the information processing apparatus.

### DETAILED DESCRIPTION OF EMBODIMENTS

Embodiments hereinafter referred to as embodiments according to the present technology are described below. Descriptions are provided as follows.

1. First Embodiment (an Example in which an Image Capture Apparatus is Detected as being Mounted, Depending on whether or not a Polling Response is Received)

2. Second Embodiment (an Example in which the Image Capture Apparatus is Detected Based on Specific Information for Specifying the Imaging Apparatus that Transmits the Polling Response)

### 1. First Embodiment

### Configuration Example of an External Appearance of the Imaging Apparatus

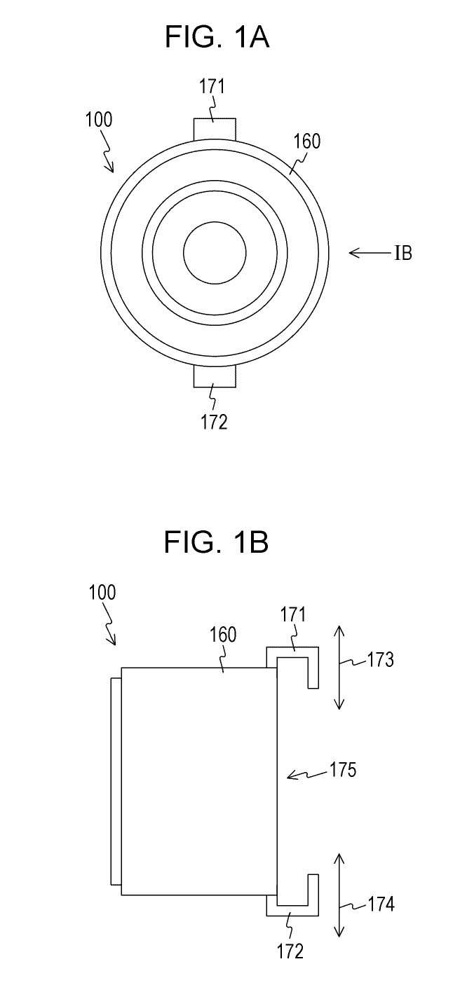

FIGS. 1A and 1B are views illustrating an external appearance of an imaging apparatus 100 according to a first embodiment of the present technology. FIG. 1A is a front view of the imaging apparatus 100. FIG. 1B is a side view (a side view when viewed from an arrow A) of the imaging apparatus 100.

Furthermore, according to the embodiment of the present technology, as an example, the imaging apparatus 100 is assumed to be an imaging apparatus (for example, a lens-style camera) in a cylindrical shape (column shape). That is, an example, the imaging apparatus 100 is assumed to have an appearance in the shape of only a lens portion that is taken out of a general imaging apparatus (for example, an integrated-type camera). Moreover, the imaging apparatus 100 includes operation members, such as a zoom lever and a shutter button, but illustration of these is omitted in FIGS. 1A and 1B and the like. Furthermore, the imaging apparatus 100, for example, is realized by a digital still camera or a digital video camera (for example, camera-integrated recorder).

The imaging apparatus 100 includes a lens barrel 160 and mounting members 171 and 172. The lens barrel 160 accommodates members, such as an optical system and an imaging system.

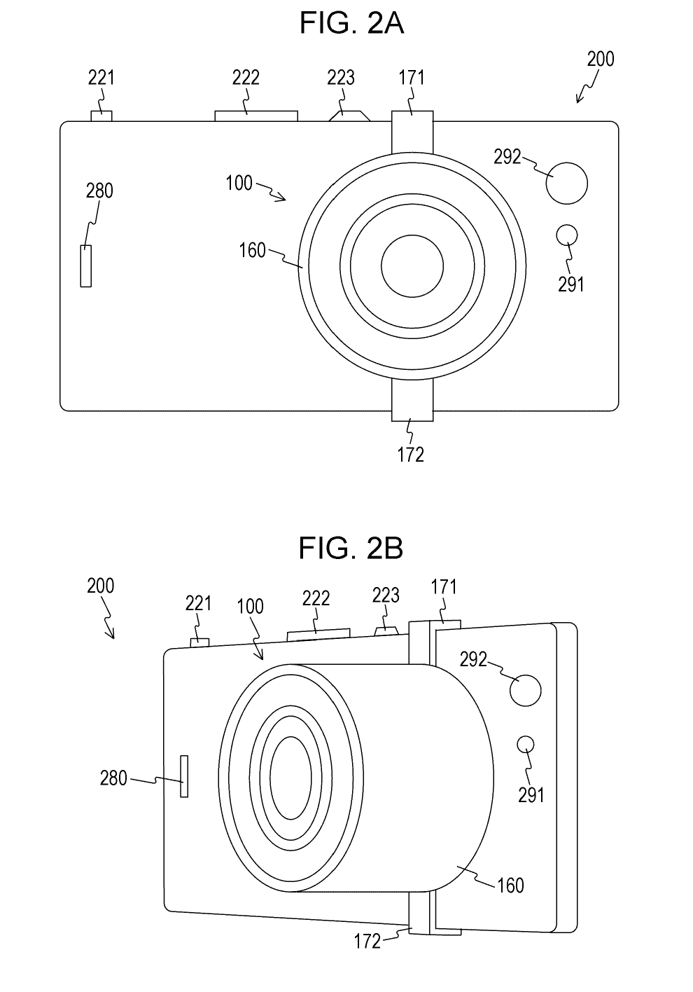

The mounting members 171 and 172 are attachments that are used when the imaging apparatus 100 is mounted on a different apparatus (for example, an information processing apparatus 200 illustrated in FIGS. 2A and 2B). For example, depending on a shape or size of the different apparatus, the mounting member 171 is moved in the direction of an arrow 173, and the mounting member 172 is moved in the direction of an arrow 174. Thus, the imaging apparatus 100 can be mounted on the different apparatus. That is, the mounting members 171 and 172 are attachments for fixing the imaging apparatus 100 to the different apparatus. Furthermore, an attachment surface, with which the imaging apparatus 100 comes into contact when the imaging apparatus 100 is mounted on the different apparatus, is illustrated as a mounting surface 175 (a surface opposite to a lens-side surface illustrated in FIG. 1A). Moreover, an example in which the imaging apparatus 100 is mounted on the different apparatus is illustrated in FIGS. 2A and 2B.

In this manner, the imaging apparatus 100, for example, is enabled to perform an ordinary imaging operation, and can be mounted on the different apparatus (for example, a smartphone) for use. Furthermore, if the imaging apparatus 100 is mounted on the different apparatus for use, the imaging apparatus 100 can be operated with remote control that is performed on the different apparatus.

Example in which the Imaging Apparatus is Mounted

FIGS. 2A and 2B are views illustrating an external configuration in which the imaging apparatus 100 according to the first embodiment of the present technology is mounted on the information processing apparatus 200.

FIGS. 2A and 2B illustrate an example in which the imaging apparatus 100 is mounted on one surface (a surface on which an imaging unit 292 is provided) of the information processing apparatus 200. FIG. 2A is a front view illustrating that the imaging apparatus 100 is mounted on the information processing apparatus 200. Furthermore, FIG. 2B is a perspective view illustrating that the imaging apparatus 100 is mounted on the information processing apparatus 200.

The information processing apparatus 200 includes operation members 221 to 223, an input and output unit 240, a voice output unit 280, a light emission unit 291, and an imaging unit 292. Moreover, the information processing apparatus 200, for example, is realized by an information processing apparatus, such as a smartphone and a tablet terminal.

The operation members 221 to 223 are operation members that are used when various operation inputs are performed.

Various images are displayed on the input and output unit 240. The operation input from a user is received by the input and output unit 240, based on a detected state of an object that comes into close proximity to or comes into contact with a display surface of the input and output unit 240.

The voice output unit 280 outputs various pieces of voice information.

The light emission unit 291 is a light emission device that emits light to a photographic subject. The light emission unit 291, for example, is used when an imaging operation is performed using the information processing apparatus 200 in an environment where it is difficult to expect sufficient brightness, such as at night or indoors.

The imaging unit 292 images the photographic subject and thus generates an image (image data).

As illustrated in FIGS. 2A and 2B, a main body of the information processing apparatus 200 is held in place between the mounting members 171 and 172 of the imaging apparatus 100, and thus the imaging apparatus 100 can be fixed to the information processing apparatus 200. Moreover, the imaging apparatus 100 may be mounted on a different portion of the information processing apparatus 200 (portion other than the portion illustrated in FIGS. 2A and 2B).

Example of a Functional Configuration of the Imaging Apparatus and the Information Processing Apparatus

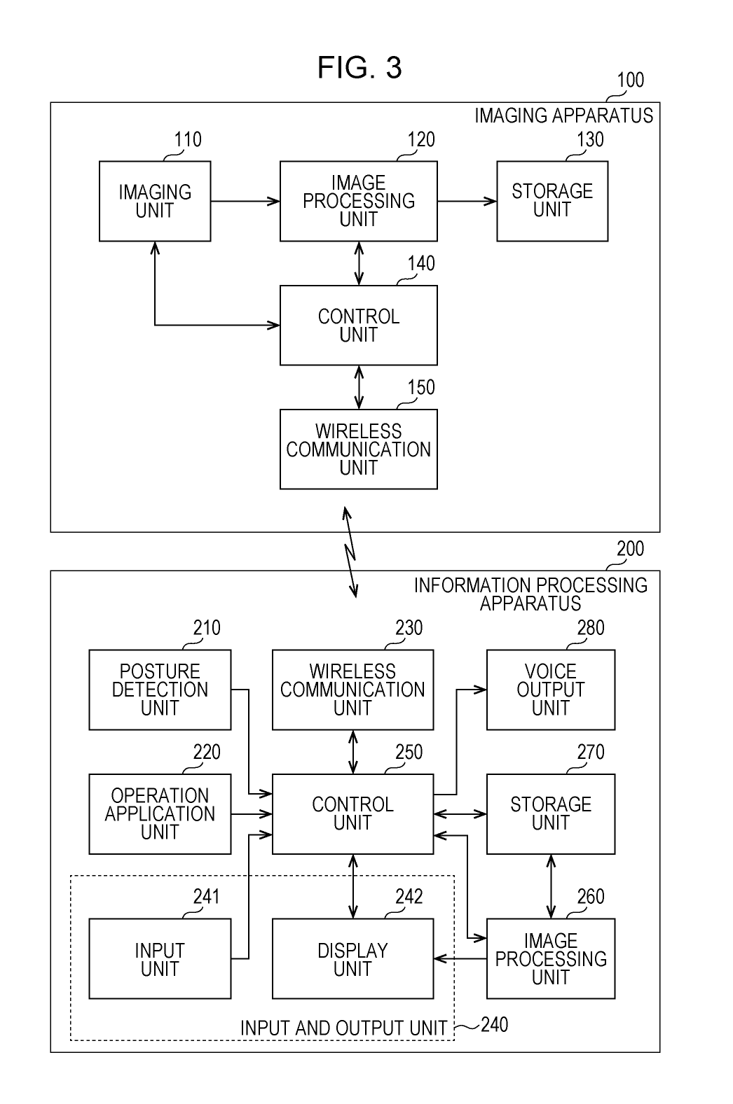

FIG. 3 is a block diagram illustrating an example of a functional configuration of the imaging apparatus 100 according to the first embodiment of the present technology and of the information processing apparatus 200. Moreover, an imaging system configured from the imaging apparatus 100 and the information processing apparatus 200 is one example of an imaging system that is recited in claims.

The imaging apparatus 100 includes an imaging unit 110, an image processing unit 120, a storage unit 130, a control unit 140, and a wireless communication unit 150.

Under the control of the control unit 140, the imaging unit 110 images the photographic subject and thus generates the image (image data) and outputs the generated image to the image processing unit 120. The imaging unit 110, for example, is configured from an optical system (multiple lenses) and imaging elements. Furthermore, each unit (for example, a zoom lens, a focal lens, or a diaphragm) of the imaging unit 110 is controlled under the control of the control unit 140. Moreover, according to the embodiment of the present technology, an “image,” when used in the present specification, is defined as meaning both the image as is, and image data for displaying the image.

Under the control of the control unit 140, the image processing unit 120 performs predetermined image processing (for example, de-mosaic processing) on the image that is output from the imaging unit 110, and stores in the storage unit 130 the image on which the image processing is performed. Moreover, the image on which the image processing unit 120 performs the image processing may be transmitted to the information processing apparatus 200 using wireless communication and thus be stored in the storage unit 130.

The storage unit 130 is a recording medium on which the image on which the image processing unit 120 performs the image processing is stored as content (for example, a static image file or a moving image file). Moreover, the storage unit 130 may be built into the imaging apparatus 100 and be removable from the imaging apparatus 100.

The control unit 140 controls each unit of the imaging apparatus 100, based on a control program. For example, the control unit 140 controls each unit, based on the operation input that is received by the operation member (not illustrated) that is provided to the imaging apparatus 100, such as the zoom lever and the shutter button. Furthermore, the control unit 140 controls each unit, based on control information from the information that is transmitted from the processing apparatus 200 through the wireless communication unit 150. That is, the imaging apparatus 100 can be remotely operated using the information processing apparatus 200.

Under the control of the control unit 140, the wireless communication unit 150 performs transmission and reception of each piece of information (for example, control data, or the image data) between the imaging apparatus 100 and a different information processing apparatus (for example, the information processing apparatus 200) using the wireless communication technology.

At this point, for the wireless communication, for example, wireless communication technologies can be used such as Near Field Communication (NFC), and Wireless Local Area Network (LAN). As the Wireless LAN, for example, Wireless Fidelity (Wi-Fi) can be used. Furthermore, for the wireless communication, for example, wireless communication technologies can be used such as Bluetooth (registered trademark), Infrared Data Association (IrDA), and a radio wave technology for a mobile terminal.

Furthermore, multiple wireless communication methods can be used. For example, when the wireless communication is started, only exchange of data (for example, Service Set Identifier (SSID)) on power-on and the Wi-Fi is performed by the NFC. Then, the exchange of the data thereafter can be performed by Wi-Fi.

Furthermore, for example, when it is detected that the imaging apparatus 100 is mounted on the information processing apparatus 200, the exchange of the data can be performed by the NFC. Furthermore, the exchange of the image data or the control data between the imaging apparatus 100 and the information processing apparatus 200 can be performed using Wi-Fi.

The information processing apparatus 200 includes a posture detection unit 210, an operation application unit 220, a wireless communication unit 230, the input and output unit 240, a control unit 250, an image processing unit 260, a storage unit 270, and the voice output unit 280.

The posture detection unit 210 detects a change in a posture of the information processing apparatus 200 by detecting acceleration, movement, inclination, and the like of the information processing apparatus 200, and outputs to the control unit 250 position information relating to the detected change in the position. Moreover, as the posture detection unit 210, for example, various sensors can be used such as a gyro sensor and acceleration sensor.

The operation application unit 220 is an operation application unit on which the user performs an operation, and outputs to the control unit 250 the control information (operation information) according to content of the performed operation. Moreover, the operation application unit 220 corresponds to the operation members 221 to 223 illustrated in FIGS. 2A, 2B, and 3.

Under the control of the control unit 250, the wireless communication unit 230 performs the transmission and reception of each piece of information (for example, the control data or the image data) between the information processing apparatus 200 and a different information processing apparatus (for example, the imaging apparatus 100) using the wireless communication technology. For the wireless communication, for example, the wireless communication technologies can be used such as Wireless LAN (for example, Wi-Fi), NFC, Bluetooth, and Infrared Data Association (IrDA) which are described above, and a radio wave for a mobile device. Furthermore, multiple wireless communication methods may be used.

The input and output unit 240 is configured as one piece into which an input unit 241 and the display unit 242 are integrated. Furthermore, under the control of the control unit 250, the input and output unit 240 displays various images on the display unit 242, and the input unit 241 receives the operation input from the user, based on a detected state of an object that comes into close proximity to, or comes into contact with a display surface of the display unit 242. Furthermore, the input unit 241 outputs the control information to the control unit 250 according to the received operation input.

For example, as the input unit 241, an electrostatic type (capacitance type) touch panel can be used that detects the contact of or the close proximity to an object having conductivity (for example, a human finger) based on a change in capacitance. Furthermore, for example, as the display unit 242, a display panel can be used such as a Liquid Crystal Display (LCD), or an organic Electro Luminescence (EL) panel. Then, the input and output unit 240, for example, is configured such that the input and output unit 240 is obtained by superimposing a transparent touch panel on a display surface of the display panel.

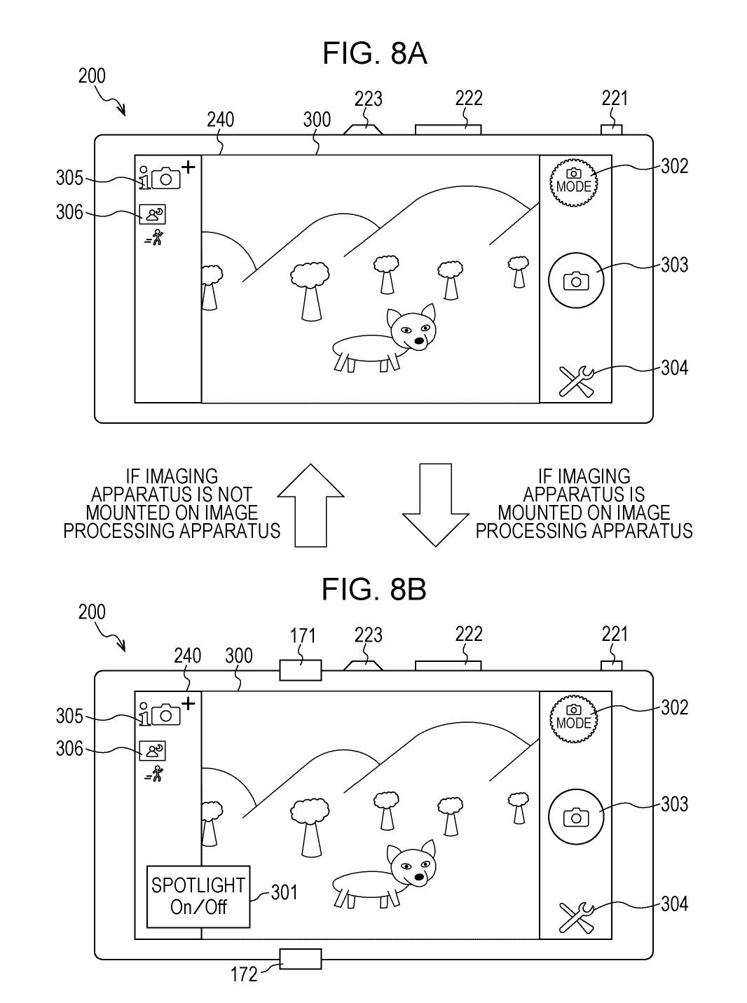

For example, the user can perform a contact operation (or a close proximity operation) on an operation target object or the like that is displayed on the display unit 242, and thus operation of the information processing apparatus 200 or of the imaging apparatus 100 is made possible. At this point, like operation target objects 301 to 306 illustrated in FIG. 8B, the operation target object, for example, is displayed on the input and output unit 240, and is an operation button (a Graphical User Interface (GUI) button) or the like for performing the operation input.

The control unit 250 controls each unit of the information processing apparatus 200 based on the control program. For example, the control unit 250 determines the posture of the information processing apparatus 200 based on the position information from the posture detection unit 210, and switches a display state of a display screen that is displayed on the input and output unit 240 based on the result of the determination. For example, the control unit 250 determines upward and downward directions of the posture of the information processing apparatus 200 based on the position information from the posture detection unit 210, and exchanges upward and downward directions of the display state of the display screen that is displayed on the input and output unit 240 based on the result of the determination.

Furthermore, for example, if the information processing apparatus 200 and the imaging apparatus 100 are connected to each other through the wireless communication unit 230, the control unit 250 displays on the input and output unit 240 the display screen for operating the imaging apparatus 100. In this case, the control unit 250 performs control that switches the display state of the display screen for operating the imaging apparatus 100 based on a relative positional relationship between the information processing apparatus 200 and the imaging apparatus 100. For example, the control unit 250 performs the control that switches the display state of the display screen based on a distance between the information processing apparatus 200 and the imaging apparatus 100. In this case, for example, the control unit 250 displays the display screen that includes the operation target object (for example, operation target objects 301 to 306 illustrated in FIGS. 8A and 8B) for operating the imaging apparatus 100, and performs the control that switches the display state of the operation target object based on the relative positional relationship.

Furthermore, for example, the control unit 250 performs the control that switches the display state of the display screen, based on whether or not the imaging apparatus 100 is mounted on the information processing apparatus 200. In this case, the control unit 250 may perform the control that switches the display state of the display screen, based on whether or not the imaging apparatus 100 is mounted on the display surface of the input and output unit 240. Furthermore, if the imaging apparatus 100 is mounted on the display surface of the input and output unit 240, the control unit 250 may perform the control that switches the display state of the display screen, based on the position of the imaging apparatus 100 on the display surface of the input and output unit 240.

In this manner, in the information processing apparatus 200, the display screens are switched based on the relative positional relationship between the imaging apparatus 100 and the information processing apparatus 200 that are connected to each other using the wireless communication. Furthermore, the control unit 140 of the imaging apparatus 100 performs control relating to the imaging operation, based on the operation input that is performed through the display screen of the information processing apparatus 200 and that is performed in the information processing apparatus 200 on which the display screen is displayed.

Under the control of the control unit 250, the image processing unit 260 performs predetermined image processing on the image that is generated by the imaging apparatus 100 or the image that is generated by the imaging unit 292 (illustrated in FIG. 2B), and displays on the display unit 242 the image on which the predetermined image processing is performed. Furthermore, the image processing unit 260 stores these images in the storage unit 270, based on the control of the control unit 250. Furthermore, under the control of the control unit 250, the image processing unit 260 displays on the display unit 242 the display screen that is used when the imaging operation is performed with the imaging apparatus 100.

The storage unit 270 is a recording medium on which each piece of information is stored under the control of the control unit 250. For example, the image that is generated by the imaging apparatus 100 or the image that is generated by the imaging unit 292 (illustrated in FIG. 2B) is stored as content (for example, a static image file, or a moving image file) in the storage unit 270. Moreover, the storage unit 270 may be built into the information processing apparatus 200 and may be removable from the information processing apparatus 200.

The voice output unit 280 outputs the voice information under the control of the control unit 250. The voice output unit 280, for example, can be realized by a speaker.

Example in which the Imaging Apparatus and the Information Processing Apparatus are Used

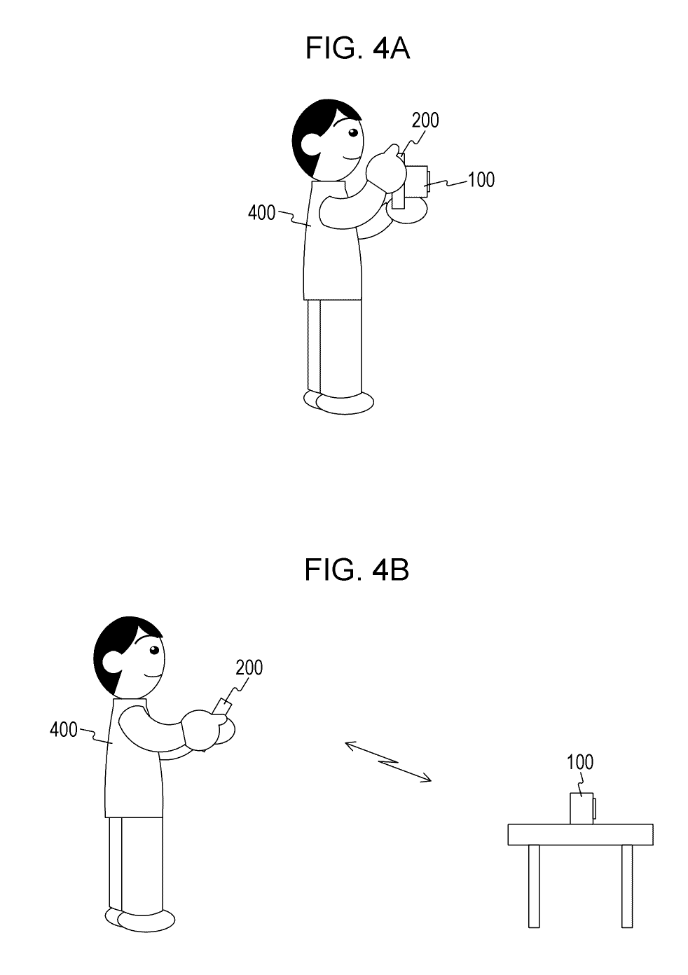

FIGS. 4A and 4B are views illustrating an example in which the imaging apparatus 100 according to the first embodiment of the present technology and the information processing apparatus 200 are used.

FIG. 4A illustrates one example in which the imaging apparatus 100 is mounted on the information processing apparatus 200 and thus the mounted imaging apparatus 100 is used. For example, as illustrated in FIGS. 2A and 2B, the imaging apparatus 100 can be mounted on one surface (surface opposite to the surface to which the input and output unit 240 is provided) of the information processing apparatus 200. In this case, a user 400 can perform photographing using the information processing apparatus 200 on which the imaging apparatus 100 is mounted, in the same manner as he/she does using a general imaging apparatus (for example, in an integrated-type camera).

FIG. 4B illustrates one example in which the imaging apparatus 100 is used without being mounted on the information processing apparatus 200. For example, as illustrated in FIG. 4B, the imaging apparatus 100 can be placed in a place that is away from the information processing apparatus 200. Even in this case, because the user 400 can remotely operate the imaging apparatus 100 using the information processing apparatus 200, the photographing can be performed with the imaging apparatus 100 and the information processing apparatus 200.

At this point, in a case where the imaging apparatus 100 is mounted on the information processing apparatus 200 and in other cases, it is assumed that the information processing apparatus 200 differs in use state (for example, how to hold the information processing apparatus 200). Accordingly, according to the first embodiment of the present technology, an example is illustrated in which the display states of the display screen are switched based on whether or not the imaging apparatus 100 is mounted on the information processing apparatus 200. Furthermore, because the display state of the display screen is appropriately switched, it is important to appropriately detect that the imaging apparatus 100 is mounted on the information processing apparatus 200. Accordingly, according to the embodiment of the present technology, an example is illustrated in which, using short-range wireless communication (for example, the NFC), it is appropriately detected that the imaging apparatus 100 is mounted on the information processing apparatus 200.

Example in which the Mounting of the Imaging Apparatus is Detected

According to the embodiment of the present technology, an example is illustrated in which, using short-range wireless communication, it is detected that the imaging apparatus 100 is mounted on the information processing apparatus 200. At this point, an example is illustrated in which for the short-range wireless communication, the Near Field Communication (NFC) is used.

For example, with the NFC, periodical communication is performed between the apparatuses. For example, a polling command is periodically issued from the information processing apparatus 200. The polling command is a command for determining a NFC tag that is established in accordance with NFC specifications (for example, refer to NFC Forum Type3 Tag Operation Specification NFC Forum-TS-Type-3-Tag_{—}1.1).

For example, if a response (polling response) to the polling command that is periodically issued is present, the information processing apparatus 200 can determine that an approaching apparatus is present. At this point, a distance over which data communication is possible by using the NFC ranges from 1 cm to 10 cm. Accordingly, if the polling response is present, the control unit 250 of the information processing apparatus 200 can determine that the imaging apparatus 100 is mounted on the information processing apparatus 200.

Furthermore, if the response (polling response) to the polling command is not present, the information processing apparatus 200 can determine that an approaching apparatus is not present. In this case, the control unit 250 of the information processing apparatus 200 can determine that the imaging apparatus 100 is not mounted on the information processing apparatus 200.

At this point, NFC is one of wireless communication technologies that have come into wide use. Furthermore, in most cases, the information processing apparatus such as the smartphone is equipped with NFC. For this reason, if the information processing apparatus is equipped with NFC, the detection of the mounting using the NFC makes it unnecessary to newly install software for performing the detection of the mounting. Accordingly, a cost of manufacturing the information processing apparatus can be reduced.

At this point, for example, it is assumed that the imaging apparatus and the information processing apparatus approach each other without the imaging apparatus being mounted on the information processing apparatus. In such a case, when the detection of the mounting is performed using short-range wireless communication other than the NFC, there is concern that the imaging apparatus will be erroneously detected as being mounted. Accordingly, according to the embodiment of the present technology, for the short-range wireless communication, the NFC is used. Accordingly, the precision with which the mounting of the imaging apparatus is detected can be enhanced.

### Communication Example

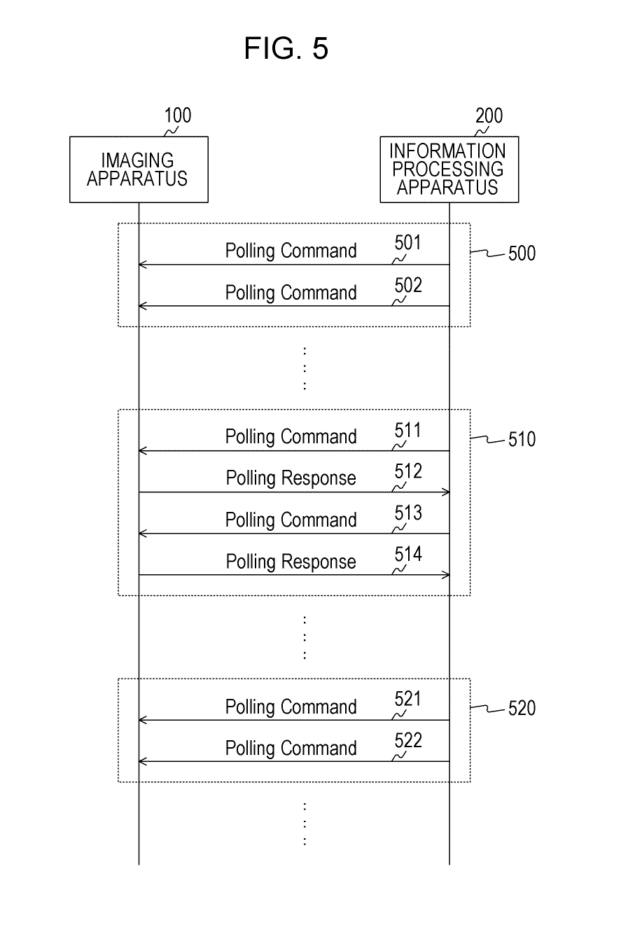

FIG. 5 is a sequence chart illustrating an example of communication processing between the imaging apparatus 100 according to the first embodiment of the present technology and the information processing apparatus 200.

FIG. 5 illustrates an example in which the information processing apparatus 200 functions as an NFC reader/writer and the imaging apparatus 100 functions as an NFC tag. Furthermore, it is assumed that in the information processing apparatus 200, the issuing of the polling command is performed according to an operation (user's manual operation) of switching on/off the issuing of the polling command. Furthermore, it is assumed that in the imaging apparatus 100, when the polling command is received from the information processing apparatus 200, this is defined as ON, and the response (polling response) to the polling command is performed.

Furthermore, FIG. 5 illustrates an example in which if the response (polling response) to the polling command that is periodically issued is present, it is determined that the imaging apparatus 100 is mounted on the information processing apparatus 200.

In FIG. 5, dotted-line rectangles 500 and 520 indicate an example of communication in which it is not detected that the imaging apparatus 100 is mounted on the information processing apparatus 200. Furthermore, a dotted-line rectangle 510 indicates an example of communication in which it is detected that the imaging apparatus 100 is mounted on the information processing apparatus 200.

If the user performs the switch operation for switching on the issuing of the polling command, the control unit 250 of the information processing apparatus 200 periodically issues the polling command (501, 502, 511, 513, 521, and 522).

At this point, if a distance between the imaging apparatus 100 and the information processing apparatus 200 is such that the distance is a threshold or above, it is difficult for the imaging apparatus 100 to receive the polling command. For the reason, as indicated by the dotted-line rectangles 500 and 520, the imaging apparatus 100 does not transmit the response (polling response) to the polling command. In this case, it is difficult for the control unit 250 of the information processing apparatus 200 to receive the response (polling response) to the polling command. For this reason, the control unit 250 of the information processing apparatus 200 determines that the imaging apparatus 100 is not mounted.

Furthermore, if the distance between the imaging apparatus 100 and the information processing apparatus 200 is such that the distance is below the threshold, the imaging apparatus 100 can receive the polling command. In this manner, the control unit 140 of the imaging apparatus 100 that receives the polling command transmits the response (polling responses) to the polling command as indicated by the dotted-line rectangle 510 (512 and 514). In this case, the control unit 250 of the information processing apparatus 200 can receive the response (polling response) to the polling command. For this reason, the control unit 250 of the information processing apparatus 200 determines that the imaging apparatus 100 is mounted.

At this point, in most cases, an antenna in the shape of a rectangle, of which a length of one side is predetermined (for example, approximately 7 mm) is used as an NFC antenna. Furthermore, as described above, the distance over which the data communication is possible by using the NFC ranges approximately from 1 cm to 10 cm. For this reason, in order to detect the mounting of the imaging apparatus 100 using the NFC, it is necessary to mount the imaging apparatus 100 on a portion on which an antenna of the information processing apparatus 200 is arranged (or close to the portion on which the antenna is arranged). Accordingly, the antenna (NFC antenna) of the information processing apparatus 200 may be arranged on the portion suitable for mounting the imaging apparatus 100.

Example of Operation of the Information Processing Apparatus

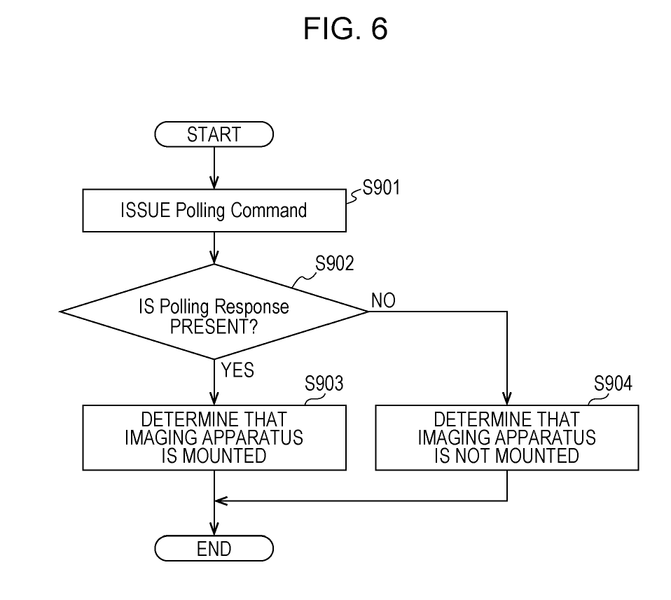

FIG. 6 is a flow chart illustrating, as one example, processing steps of mounting-detection processing by the information processing apparatus 200 according to the first embodiment of the present technology. FIG. 6 illustrates an example in which if the response (polling response) to the polling command that is periodically issued is present, it is determined that the imaging apparatus is mounted.

First, the control unit 250 issues the polling command (Step S901). Subsequently, the control unit 250 determines whether or not the response (polling response) to the polling command is received (Step S902).

If the polling response is received (Step S902), the control unit 250 determines that a different apparatus (for example, the imaging apparatus 100) is mounted on the information processing apparatus 200 (Step S903). On the other hand, if the polling response is not received (Step S902), the control unit 250 determines that a different apparatus is not mounted on the information processing apparatus 200 (Step S904). Moreover, Steps S901 and S902 are one example of a wireless communication step that is recited in claims. Furthermore, Steps S902 to S904 are one example of a determination step that is recited in claims.

In this manner, the control unit 250 determines whether or not the imaging apparatus 100 is mounted, based on a result of the communication between the information processing apparatus 200 and the imaging apparatus 100 that uses the short-range wireless communication (NFC). For example, the wireless communication unit 230 transmits a command for polling (polling command), under the control of the control unit 250. Furthermore, if the command for polling (polling command) is received from the information processing apparatus 200, the control unit 140 of the imaging apparatus 100 transmits the response (polling response) to the command. Then, if the response (polling response) to the command is received, the control unit 250 determines that the imaging apparatus 100 is mounted. If the response to the command is not received, the control unit 250 determines that the imaging apparatus 100 is not mounted.

In this manner, the information processing apparatus 200 determines whether or not the imaging apparatus 100 is mounted on the information processing apparatus 200, based on the result of the communication between the imaging apparatus 100 and the information processing apparatus 200 that uses the short-range wireless communication (NFC). Furthermore, the control unit 140 of the imaging apparatus 100 performs the control relating to the imaging operation, based on the operation input that is performed in the information processing apparatus 200. That is, the first embodiment of the present technology is one example of a method of controlling the imaging apparatus 100, the method including a wireless communication step of performing the communication between the imaging apparatus 100 and the information processing apparatus 200, and a control step of performing the control relating to the imaging operation based on the operation input that is performed in the information processing apparatus 200.

Moreover, in the example illustrated in FIG. 6, the mounting of the different apparatus is detected under the condition that the polling response is received, but the mounting of the different apparatus may be detected using other conditions. For example, a condition that the polling response is received only for a predetermined time may be established, and a condition that only a predetermined number of the polling responses are received may be established.

Example in which the Display Screens are Switched

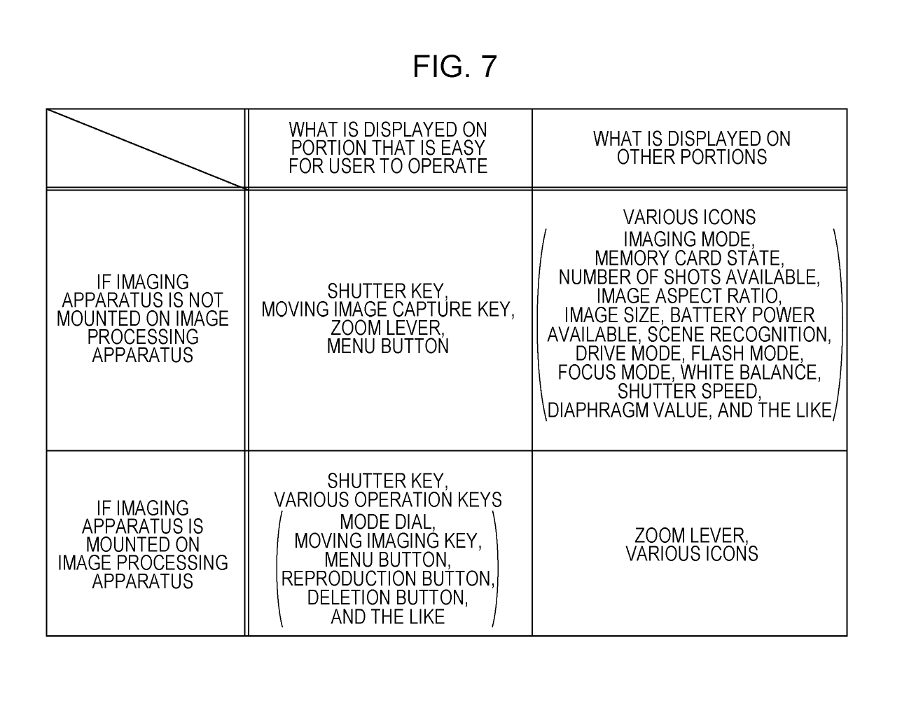

FIG. 7 is a view illustrating an example in which the display screens that are displayed on the input and output unit 240 according to the first embodiment of the present technology are switched. FIG. 7 illustrates an example in which the imaging apparatus 100 is not mounted on the information processing apparatus 200 and an example in which the imaging apparatus 100 is mounted on the information processing apparatus 200.

For example, it is assumed that if the imaging apparatus 100 is not mounted on the information processing apparatus 200 (a non-mounting case), a change in setting does not occur comparatively frequently during photographing. For example, it is desirable that the number of the operation target objects (for example, operation keys) which are displayed on the input and output unit 240 be limited to the minimum for a simple configuration. For example, as illustrated in FIG. 7, a shutter key, a moving image capture key, a zoom key, a menu key, and the like can be displayed on a portion of the input and output unit 240, which is easy for the user to operate. Furthermore, various icons and the like can be displayed on portions other than such a portion.

At this point, for example, the portion that is easy for the user to operate means a right-side region or left-side region of the input and output unit 240 for the right-handed or left-handed user, respectively.

Furthermore, for example, it is assumed that if the imaging apparatus 100 is mounted on the information processing apparatus 200, the change in setting occurs comparatively frequently during photographing. For example, it is assumed that the user performs a ring operation or a zoom operation while supporting the lens barrel 160 of the imaging apparatus 100 with his/her left hand, and performs a button operation with his/her right hand. For this reason, it is desirable that various operation target objects such as setting buttons be arranged on the input and output unit 240. For example, as illustrated in FIG. 7, the shutter key, various operation keys, and the like can be displayed on the portion of the input and output unit 240, which is easy for the user to operate. Furthermore, the zoom lever, the various icons, and the like can be displayed on portions other than such a portion.

Moreover, these examples of display switching are illustrative, and display switching other than these examples may be possible. Other examples of display switching are described below.

Example in which the Display Screen is Displayed

FIGS. 8A to 10B are views illustrating an example in which the display screen that is displayed on the input and output unit 240 according to the first embodiment of the present technology is displayed.

FIGS. 8A to 10A illustrate examples in which the imaging apparatus 100 is not mounted on the information processing apparatus 200. FIGS. 8A to 10B illustrate examples in which the imaging apparatus 100 is mounted on the information processing apparatus 200.

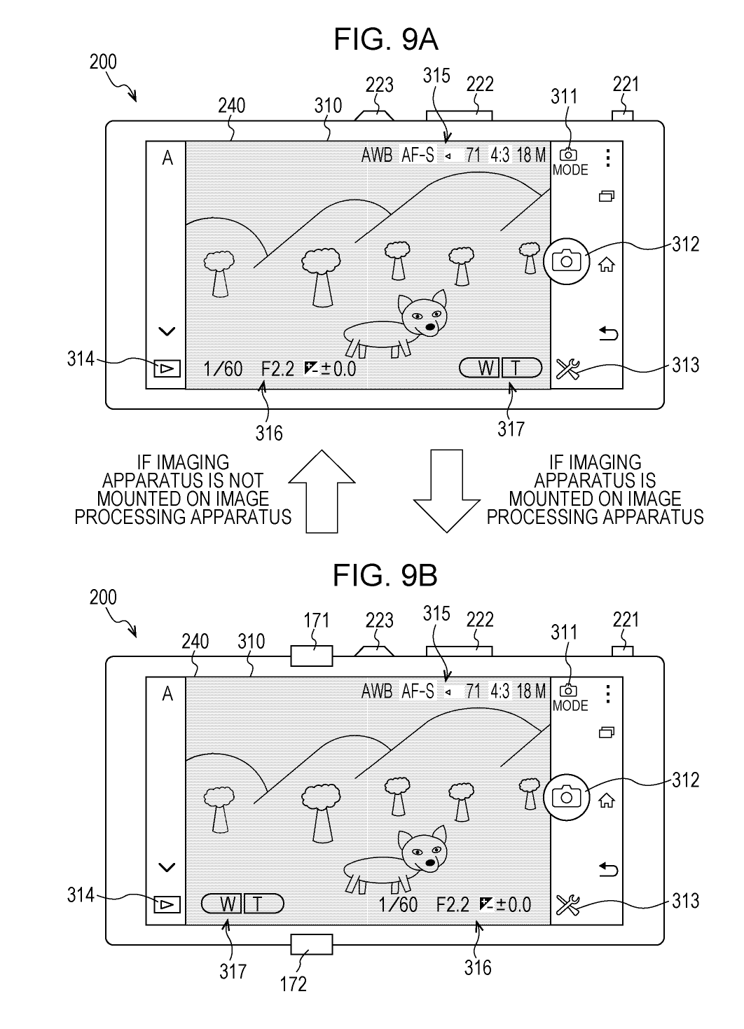

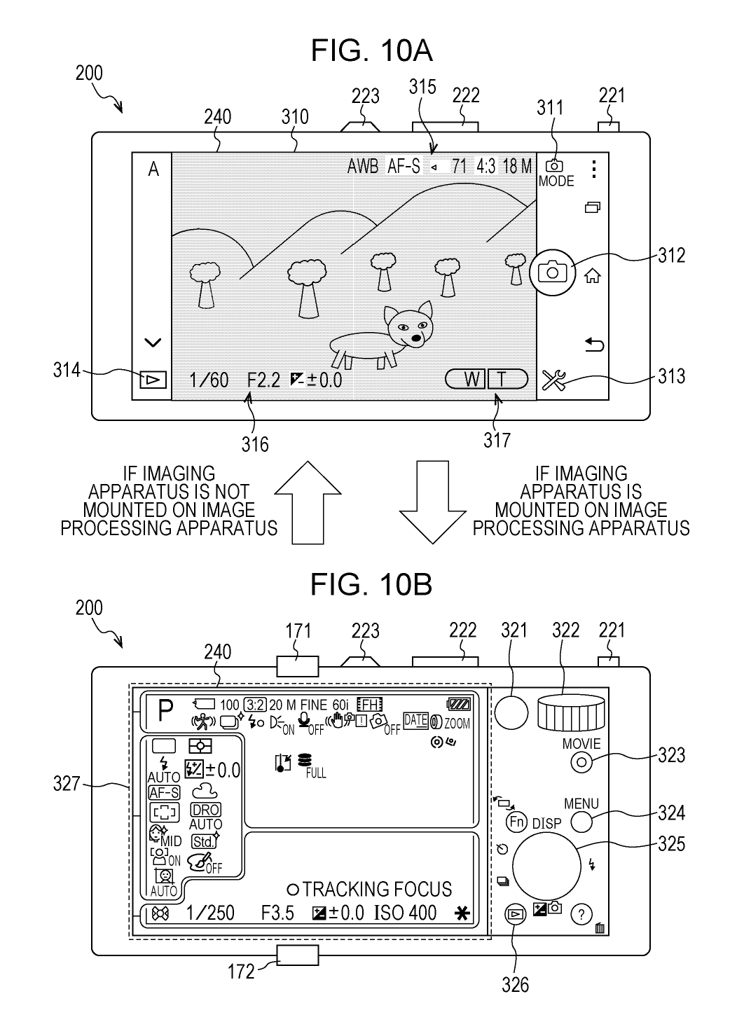

Furthermore, FIGS. 8A to 10B illustrate examples in which if the imaging operation is performed with the imaging apparatus 100 and the information processing apparatus 200, the image generated by the imaging unit 110 of the imaging apparatus 100 is displayed, as a real time view image, on the input and output unit 240. That is, the images generated by the imaging unit 110 of the imaging apparatus 100 are sequentially transmitted to the information processing apparatus 200 through the wireless communication units 150 and 230 and are displayed, as the real time view image, on the input and output unit 240. Moreover, the exchange of the image data or the control data between the imaging apparatus 100 and the information processing apparatus 200 can be performed using Wi-Fi. Furthermore, FIGS. 8A to 8B illustrate an example in which the image in which a mountain and a dog that walks with the mountain for a background are contained as photographic subjects is displayed as a real time view image 300. FIGS. 9A to 10A illustrate an example in which the image in which the mountain and the dog that walks with the mountain for the background are contained as the photographic subjects is displayed as a real time view image 310.

Furthermore, FIGS. 8A to 10B illustrate examples in which if the imaging operation is performed with the imaging apparatus 100 and the information processing apparatus 200, the operation target object for operating the imaging apparatus 100 is displayed on the input and output unit 240. The operation target object, for example, is displayed in the vicinity of the real time view image or is superimposed on the real time view image and thus is displayed on the input and output unit 240.

Example in which the Display States of Operation Target Objects for Turning on and Off a Light Emission Unit of the Information Processing Apparatus are Switched

FIGS. 8A and 8B illustrate the example in which the display states of the operation target object 301 for turning on and off the light emission unit 291 of the information processing apparatus 200 are switched based on whether or not the imaging apparatus 100 is mounted on the information processing apparatus 200.

FIGS. 8A and 8B illustrate the example in which the real time view image 300 is displayed and the operation target objects 305 and 306 and the operation target objects 301, 302, 303, and 304 are displayed on both sides of the real time view image 300, respectively.

Moreover, the operation target object 301 is an operation target object that is pushed down when an operation of turning on and off the light emission unit 291 of the information processing apparatus 200 is performed. Furthermore, the operation target object 302 is an operation target object that is pushed down when the imaging apparatus 100 switches to a photographing capture mode. Furthermore, the operation target object 303 is an operation target object that is pushed down when a shutter operation is performed on the imaging apparatus 100. Furthermore, the operation target object 304 is an operation target object that is pushed down when various setting operations are performed on the imaging apparatus 100. Furthermore, the operation target object 305 is an operation target object that is pushed down when the imaging apparatus 100 switches to an exposure mode. Furthermore, the operation target object 306 is an operation target object for displaying scene information that is set in the imaging apparatus 100.

For example, it is assumed that if the imaging apparatus 100 is not mounted on the information processing apparatus 200, light from the light emission unit 291 of the information processing apparatus 200 does not reach a photographic subject that is a target of the imaging by the imaging apparatus 100. For the reason, it is assumed that in most cases, the light that is emitted from the light emission unit 291 of the information processing apparatus 200 is not used as photographing support light. Accordingly, as illustrated in FIG. 8A, if the imaging apparatus 100 is not mounted on the information processing apparatus 200, the operation target object 301 is not displayed.

Furthermore, it is assumed that if the imaging apparatus 100 is mounted on the information processing apparatus 200, the light from the light emission unit 291 of the information processing apparatus 200 reaches the photographic subject that is the target of the imaging by the imaging apparatus 100. For this reason, it is assumed that the light emission unit 291 of the information processing apparatus 200 is used, because the light that is emitted from the light emission unit 291 of the information processing apparatus 200 can be used as the photographing support light. Accordingly, as illustrated in FIG. 8B, if the imaging apparatus 100 is mounted on the information processing apparatus 200, the operation target object 301 is displayed.

Example in which the Display States of the Operation Target Object for Performing the Zoom Operation are Switched

FIGS. 9A and 9B illustrate an example in which the display states of the operation target object 317 for performing the zoom operation on the imaging apparatus 100 are switched based on whether or not the imaging apparatus 100 is mounted on the information processing apparatus 200.

FIGS. 9A and 9B illustrate an example in which the real time view image 310 is displayed, the operation target objects 311, 312, 313 and the operation target object 314 are displayed on both sides of the real time view image 310, respectively, and the operation target objects 315 to 317 are displayed on the real time view image 310 in a superimposed manner. Moreover, in FIGS. 9A and 9B, descriptions are provided under the assumption that the user is right-handed.

Moreover, the operation target objects 311 to 313 correspond to the operation target objects 301 to 303 illustrated in FIGS. 8A and 8B. Furthermore, the operation target object 314 is an operation target object that is pushed down when image reproduction is performed. Furthermore, the operation target objects 315 and 316 are operation target objects for displaying various setting information on the imaging apparatus 100 and thus changing each setting. Furthermore, the operation target object 317 is an operation target object for performing the zoom operation on the imaging apparatus 100. For example, as the operation target object 317, a W (wide) button (wide-side button) and a T (Tel) button (Tel-side button) are displayed. For example, if a user operation is performed on the W button or the T button, the control unit 250 obtains the control information according to the user operation, and transmits the control information to the control unit 140 of the imaging apparatus 100 through the wireless communication units 230 and 150. If the control information is received, the control unit 140 of the imaging apparatus 100 controls driving of a zoom lens of the imaging unit 110, based on the received control information.

As described above, a main body of the imaging apparatus 100 includes the operation member (zoom lever) for performing the zoom operation. However, for example, it is also assumed that if the imaging apparatus 100 is not mounted on the information processing apparatus 200, the user may not reach the operation member (zoom lever) that is included in the main body of the imaging apparatus 100. In this case, it is difficult for the user to operate the operation member (zoom lever) that is included in the main body of the imaging apparatus 100. Accordingly, as illustrated in FIG. 9A, if the imaging apparatus 100 is not mounted on the information processing apparatus 200, the operation target object 317 is displayed on a portion that is easy for the user to operate (a right-side portion that is easy for the right-handed user to operate). In this manner, the user can easily perform the zoom operation with his/her right thumb by the operation target object 317 being arranged.

Moreover, for example, it is assumed that if the imaging apparatus 100 is mounted on the information processing apparatus 200, the user may reach the operation member (zoom lever) that is included in the main body of the imaging apparatus 100. In this case, the user can operate the operation member (zoom lever) that is included in the main body of the imaging apparatus 100. Accordingly, as illustrated in FIG. 9B, if the imaging apparatus 100 is mounted on the information processing apparatus 200, the operation target object 317 is displayed on a portion different from the portion that is easy for the user to operate. For example, display positions of the operation target objects 316 and 317 can be exchanged. In this manner, the user can easily perform an operation of setting the imaging apparatus 100 with his/her right thumb by arranging the operation target object 316.

Example in which the Display State of the Operation Target Object for Performing Various Operations on the Imaging Apparatus is Switched

FIGS. 10A and 10B illustrate an example in which the display states of operation target objects 321 to 326 for performing various operations on the imaging apparatus 100 are switched based on whether or not the imaging apparatus 100 is mounted on the information processing apparatus 200.

FIG. 10A is the same as FIG. 9A. Furthermore, the operation target objects 321 to 326 that are displayed in FIG. 10B are, for example, operation target objects that correspond to operation members, respectively, which are provided to a rear side (side opposite to a lens side) of a general imaging apparatus (for example, an integrated-type camera).

For example, the operation target object 321 is an operation target object that is pushed down when the shutter operation is performed on the imaging apparatus 100. Furthermore, the operation target object 322 is an operation target object that is used when a tracking operation is performed. The operation target object 322, for example, is equivalent to a mode dial. Like the mode dial, the operation target object 322 can perform various operations by performing an operation (tracking operation) of moving the operation target object 322 in leftward and rightward directions.

Furthermore, the operation target object 323 is an operation target object that is pushed down when an operation of starting image recording is performed on the imaging apparatus 100. The operation target object 323, for example, corresponds to a REC button for the moving image. Furthermore, the operation target object 324 is an operation target object that is pushed down when a menu screen for performing various types of setting relating to the imaging apparatus 100 is displayed. The operation target object 324, for example, corresponds to a menu button.

Furthermore, the operation target object 325 is an operation target object that is used when the tracking operation, or a determination operation is performed. The operation target object 325 is equivalent to a control wheel, and can perform a moving operation of a cursor that is displayed on the input and output unit 240 or various determination operations. Furthermore, the operation target object 326 is an operation target object that is pushed down when image reproduction is performed.

Furthermore, the real time view image or the various operation target objects (for example, an icon), and the like are displayed on a display region 327 that is enclosed by a dotted-line rectangle. Moreover, in FIG. 10B, an example is illustrated in which the various operation target objects (for example, the icon) are displayed on the display region 327.

At this point, for example, if the imaging apparatus 100 is mounted on the information processing apparatus 200, it is desirable that the imaging apparatus 100 and the information processing apparatus 200 be used like a general imaging apparatus. For example, it is assumed that the user expects operability with which he/she feels comfortable compared with the general imaging apparatus (for example, the integrated-type camera). Then, it is desirable that the operation members which are substantially the same as those in the general imaging apparatus (for example, the integrated-type camera) be arranged. Then, in FIG. 10B, an example is illustrated in which the arrangement of the operation members that are substantially the same as those in the general imaging apparatus is realized by displaying each of the operation target objects. Specifically, as illustrated in FIG. 10B, the operation target objects 321 to 326 that correspond to the operation members, respectively, which are provided to the rear side (side opposite to the lens side) of the general imaging apparatus (for example, a digital still camera) are displayed on the input and output unit 240.

Example of Operation of the Information Processing Apparatus

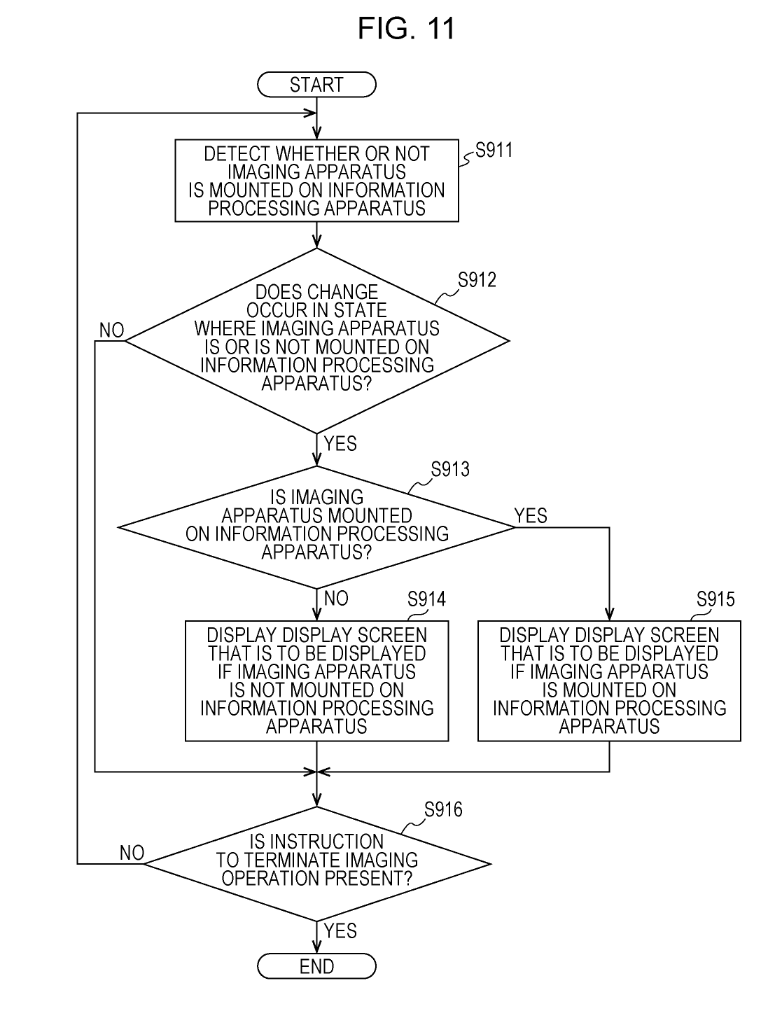

FIG. 11 is a flow chart illustrating, as one example, processing steps of display control processing by the information processing apparatus 200 according to the first embodiment of the present technology. In FIG. 11, an example is illustrated in which the display state of the input and output unit 240 is changed based on whether or not the imaging apparatus 100 is mounted on the information processing apparatus 200.

First, the control unit 250 detects whether or not the imaging apparatus 100 is mounted on the information processing apparatus 200 (Step S911).

Subsequently, the control unit 250 determines whether or not a change occurs in a state where the imaging apparatus 100 is or is not mounted on the information processing apparatus 200 (Step S912). A case where the change occurs in the state where the imaging apparatus 100 is or is not mounted on the information processing apparatus 200 means, for example, a case where the state where the imaging apparatus 100 is mounted on the information processing apparatus 200 is changed to the state where the imaging apparatus 100 is not mounted on the information processing apparatus 200, or a case where the state where the imaging apparatus 100 is not mounted on the information processing apparatus 200 is changed to the state where the imaging apparatus 100 is mounted on the information processing apparatus 200. Then, if the change does not occur in the state where the imaging apparatus 100 is or is not mounted on the information processing apparatus 200 (Step S912), proceeding to Step S916 takes place.

Furthermore, if the change occurs in the state where the imaging apparatus 100 is or is not mounted on the information processing apparatus 200 (Step S912), the control unit 250 determines whether the state that results from the occurrence of the change is the state where the imaging apparatus 100 is mounted on the information processing apparatus 200 (Step S913). If the state that results from the occurrence of the change is the case where the imaging apparatus 100 is not mounted on the information processing apparatus 200 (Step S913), the control unit 250 displays on the input and output unit 240 the display screen that is to be displayed if the imaging apparatus 100 is not mounted on the information processing apparatus 200 (Step S914). For example, the display screen illustrated in FIGS. 8A, 9A, and 10A is displayed on the input and output unit 240.

If the state that results from the occurrence of the change is the case where the imaging apparatus 100 is mounted on the information processing apparatus 200 (Step S913), the control unit 250 displays on the input and output unit 240 the display screen that is to be displayed if the imaging apparatus 100 is mounted on the information processing apparatus 200 (Step S915). For example, the display screen illustrated in FIGS. 8B, 9B, and 10B is displayed on the input and output unit 240.

Subsequently, the control unit 250 determines whether or not an instruction to terminate the imaging operation is present (Step S916). If the instruction to terminate the imaging operation is not present, the control unit 250 returns to Step S911. If the instruction to terminate the imaging operation is present, the control unit 250 terminates the display control processing.

### 2. Second Embodiment

According to the first embodiment of the present technology, the example is illustrated in which it is determined whether or not the imaging apparatus is mounted, based on whether or not the polling response is received. At this point, it is also assumed that an apparatus other than the imaging apparatus is mounted on (or approaches) the information processing apparatus. For example, it is assumed that multiple apparatuses that include the imaging apparatus function as the NFC tag. In this case, it is also assumed that when an apparatus other than the imaging apparatus is mounted on (or approaches) the information processing apparatus, it is determined that the imaging apparatus is mounted, by receiving the polling response from a different apparatus. Also in this case, it is important to appropriately detect whether the imaging apparatus is mounted.

Accordingly, according to the second embodiment of the present technology, an example is illustrated in which it is determined whether the imaging apparatus is mounted, based on specific information for specifying the imaging apparatus that transmits the polling response. Moreover, a configuration of the imaging apparatus according to the second embodiment of the present technology and the information processing apparatus is the same as that of the imaging apparatus 100 and the information processing apparatus 200 illustrated in FIGS. 1A to 3. For this reason, each apparatus according to the second embodiment of the present technology is given the same reference numeral as that according to the first embodiment of the present technology, and some descriptions of these are omitted.

### Communication Example

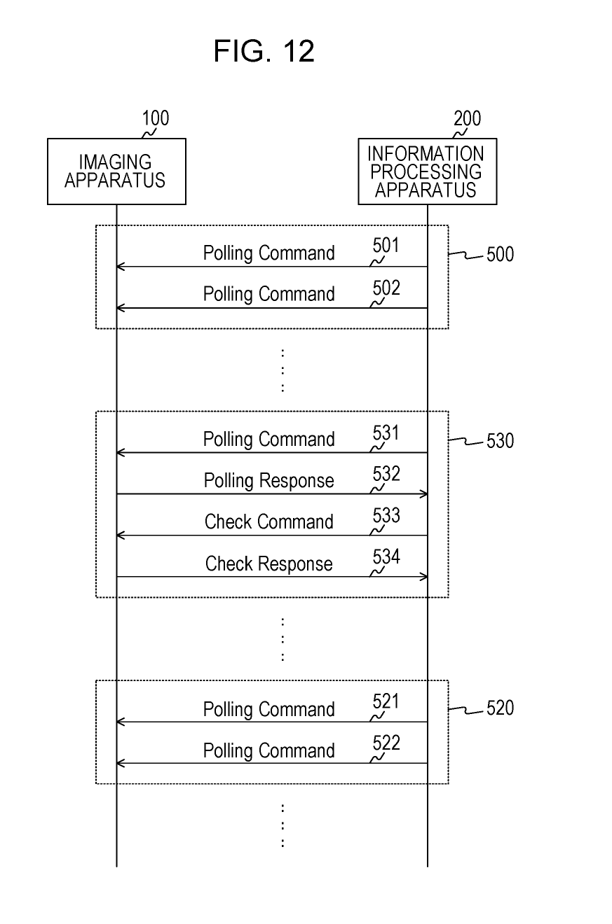

FIG. 12 is a flow chart illustrating an example of the communication processing between the imaging apparatus 100 and the information processing apparatus 200 according to the second embodiment of the present technology. Moreover, in FIG. 12, an example is illustrated in which exchange of a check command and a check response is performed, and if specific information is included in the check response, it is determined that the imaging apparatus 100 is mounted on the information processing apparatus 200. At this point, the specific information is information (identification information) for specifying the imaging apparatus 100.

At this point, the check command and the check response are commands for reading content of the NFC tag. The commands are defined in NFC Forum Type 3 Tag Operation Specification.

Furthermore, in FIG. 12, a dotted-line rectangle 530 indicates an communication example in which the imaging apparatus 100 is detected as being mounted on the information processing apparatus 200. Moreover, because dotted-ling rectangles 500 and 520 are the same as those in FIG. 5, the same reference numerals are given and descriptions of these are omitted.

If the user performs the switch operation for switching on the issuing of the polling command, the control unit 250 of the information processing apparatus 200 periodically issues the polling command (501, 502, 521, 522, and 531).

Furthermore, as indicated by the dotted-line rectangle 530, when the polling command is received (531), the control unit 140 of the imaging apparatus 100 transmits the response (polling response) to the polling command (532).

When the polling response is received (532), the control unit 250 of the information processing apparatus 200 transmits the check command (533).

Furthermore, if the check command is received (533), the control unit 140 of the imaging apparatus 100 transmits the response (check response) to the check command (534). In this case, the control unit 140 of the imaging apparatus 100 includes specific information (identification information for specifying the imaging apparatus 100) in the check response, and thus transmits the check response including the specific information (534).

For example, information indicating “ABC DSC/Lens-Style Camera” can be included, as the specific information, in the check response, and thus the check response including the information can be transmitted. At this point, it is assumed that “ABC” is information indicating a name of a company that manufactures the imaging apparatus 100, and “DSC” is information indicating that the sending apparatus is the imaging apparatus. Furthermore, it is assumed that “Lens-Style Camera” is information indicating that the sending apparatus is a lens-style camera.

In this manner, the control unit 140 of the imaging apparatus 100 includes specific information in the check response and thus transmits the check response including the specific information (534). Accordingly, the information processing apparatus 200 that receives the check response can understand that the apparatus that transmits the check response is the imaging apparatus 100, based on the specific information included in the check response. That is, it can be understood that the apparatus that transmits the check response is a “lens-style camera (imaging apparatus 100) manufactured by “ABC,” a company name.

When the check response is received (534), the control unit 250 of the information processing apparatus 200 obtains the content of the check response. Subsequently, the control unit 250 of the information processing apparatus 200 determines whether or not the specific information is included in the check response. Then, if the specific information is included in the check response, the control unit 250 of the information processing apparatus 200 determines that the imaging apparatus 100 is mounted. On the other hand, if the specific information is not included in the check response, the control unit 250 of the information processing apparatus 200 determines that the imaging apparatus 100 is not mounted.

Example of Operation of the Information Processing Apparatus

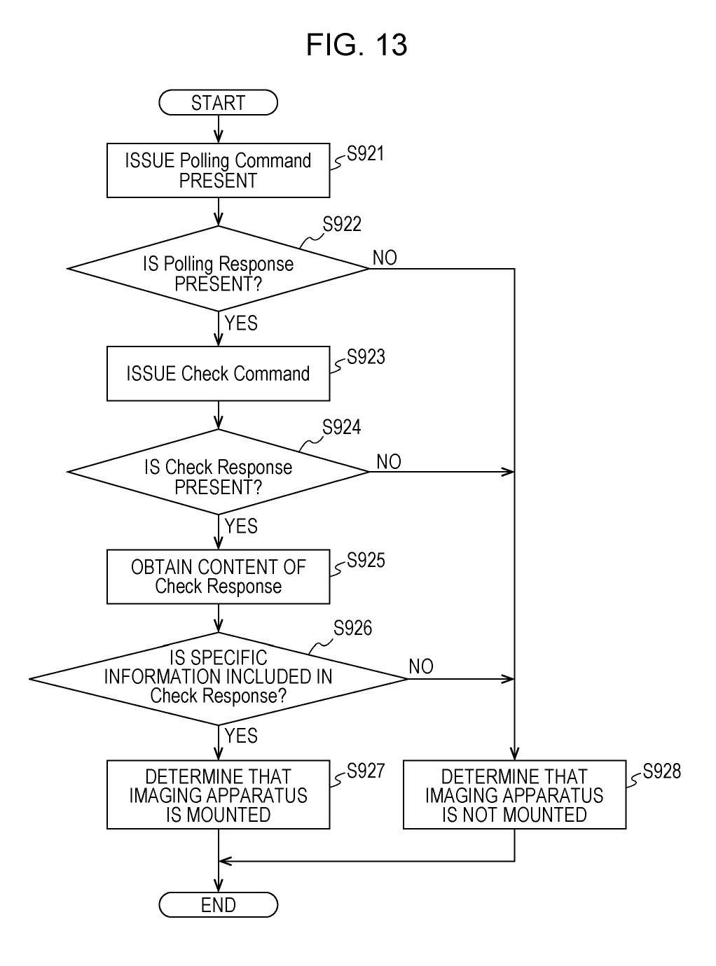

FIG. 13 is a flow chart illustrating, as one example, processing steps of mounting-detection processing by the information processing apparatus 200 according to the second embodiment of the present technology. In FIG. 13, an example is illustrated in which the exchange of the check command and the check response is performed, and if the specific information is included in the check response, it is determined that the imaging apparatus is mounted.

First, the control unit 250 issues the polling command (Step S921). Subsequently, the control unit 250 determines whether or not the response (polling response) to the polling command is received (Step S922). If the polling response is not received (Step S922), the control unit 250 determines that the imaging apparatus 100 is not mounted on the information processing apparatus 200 (Step S928).

If the polling response is received (Step S922), the control unit 250 issues the check command (Step S923). Subsequently, the control unit 250 determines whether or not the response (check response) to the check command is received (Step S924). If the check response is not received (Step S924), the control unit 250 determines that the imaging apparatus 100 is not mounted on the information processing apparatus 200 (Step S928).

When the check response is received (Step S924), the control unit 250 obtains the content of the received check response (Step S925). Subsequently, the control unit 250 determines whether or not the specific information is included in the check response (Step S926).

If the specific information is included in the check response (Step S926), the control unit 250 determines that the imaging apparatus 100 is mounted on the information processing apparatus 200 (Step S927). On the other hand, if the specific information is not included in the check response (Step S926), the control unit 250 determines that the imaging apparatus 100 is not mounted on the information processing apparatus 200 (Step S928).

In the manner, if the response (polling response) to the command (polling command) is received, the control unit 250 transmits the check command for reading information relating to the imaging apparatus 100. Furthermore, the control unit 140 of the imaging apparatus 100 includes specific information for specifying the imaging apparatus 100 in the response (check response) to the check command (check command) and thus transmits the response. Then, only if the specific information is included in the response (check response) to the check command, the control unit 250 determines that the imaging apparatus 100 is mounted.

Moreover, if the specific information is included in the check response, the control unit 250 may determine that the imaging apparatus 100 is mounted, and may perform control for activating an application in the imaging apparatus 100. The application, for example, is an application for controlling the imaging operation by the imaging apparatus 100 using the information processing apparatus 200.

Furthermore, a different piece of information may be included as the specific information that is included in the check response. For example, information indicating whether or not the imaging apparatus 100 is mounted on the information processing apparatus 200 can be included as specific information in the check response. If the check response including the specific information is received, each time the polling response is received using the NFC thereafter, the control unit 250 determines that the imaging apparatus 100 is mounted on the information processing apparatus 200.

Example of Content in a Data Format

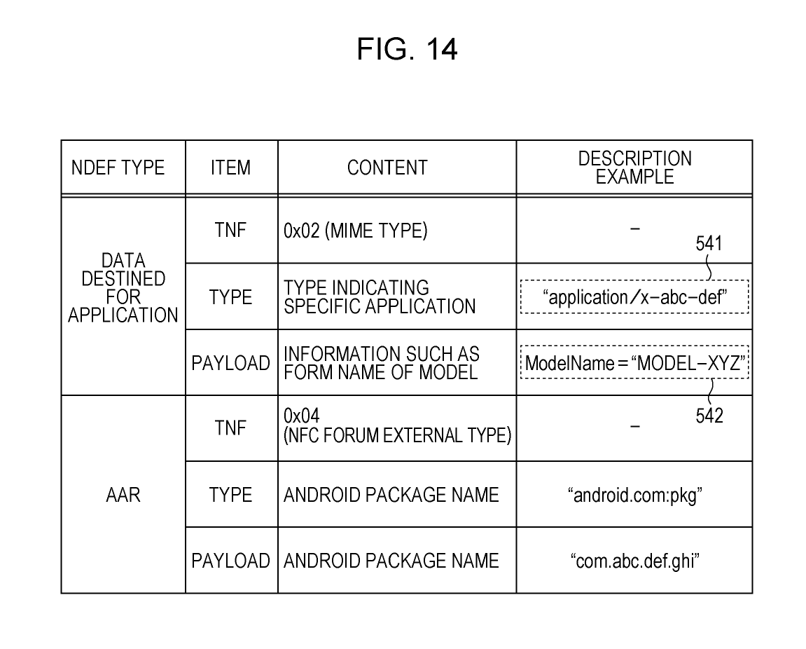

The example is described above in which “ABC DSC/Lens-Style Camera” is included as specific information in the check response. However, a different piece of information for specifying the NFC tag may be included as specific information in the check response. Thus, in FIG. 14, an NFC data exchange format (NDEF) is illustrated as one example of a data format that is used when items of data are exchanged using the NFC.

FIG. 14 is a view illustrating a specification example of the NDEF that is exchanged between the imaging apparatus 100 and the information processing apparatus 200 according to the second embodiment of the present technology.

FIG. 14 illustrated a type, an item, content, and a description example of the NDEF in a correlated manner.

In the upper portion of FIG. 14, the specification example of the NDEF that is exchanged between tags for an application is illustrated. Furthermore, in the lower portion of FIG. 14, the specification example of the NDEF that is exchanged between tags (so-called tags for Android application record (AAR) for an Android (a registered trademark)) device is illustrated.

For example, with regard to data destined for an application, from information that is enclosed by a dotted-line rectangle 541, it can be determined that the transmitting apparatus is an imaging apparatus manufactured by abc, a company name.

Furthermore, for example, with regard to the data destined for the application, information, such as a form name of a model, is stored as information that is enclosed by a dotted-line rectangle 542. From such information, for example, it can be determined that the transmitting apparatus is a specific-type imaging apparatus (for example, a lens-style camera).

Moreover, it may be determined whether the imaging apparatus 100 is mounted, considering a distance between the imaging apparatus 100 and the information processing apparatus 200.

For example, the distance between the imaging apparatus 100 and the information processing apparatus 200 can be estimated using strength of a received radio wave. For example, a table showing a relationship between the strength of the received radio wave and the distance is created in advance and is stored in the storage unit 270. Then, the control unit 250 of the information processing apparatus 200 can obtain from the table a distance corresponding to the strength of the received radio wave that is obtained by the wireless communication unit 230, and can use such a distance as the distance between the imaging apparatus 100 and the information processing apparatus 200.

Furthermore, the distance between the imaging apparatus 100 and the information processing apparatus 200 may be detected using another sensor. For example, a distance sensor (for example, a sensor that detects a distance using infrared light or an ultrasonic wave) can be used. Furthermore, for example, the distance between the imaging apparatus 100 and the information processing apparatus 200 may be detected using a global positioning system (GPS). For example, positions of the imaging apparatus 100 and of the information processing apparatus 200 are obtained using GPS, and based on these positions, the distance between the imaging apparatus 100 and the information processing apparatus 200 can be calculated. Moreover, the method of detecting the distance, described above, is one example and a limitation to this method is not imposed. Other detection methods may be used.

It may be determined, as described above, that the imaging is mounted, under the condition that the distance between the imaging apparatus 100 and the information processing apparatus 200 that is calculated in this manner is below a threshold (for example, 10 cm).

Furthermore, it may be detected that the imaging apparatus 100 is mounted, considering a state of communication between the imaging apparatus 100 and the information processing apparatus 200. For example, it may be determined, as described above, that the imaging apparatus 100 is mounted, under the condition that data communication (for example, data communication using Wi-Fi) between the imaging apparatus 100 and the information processing apparatus 200 is performed.

In this manner, according to the embodiments of the present technology, it can be precisely detected whether or not the imaging apparatus 100 is mounted on (or comes into close contact with) the information processing apparatus 200, using the NFC. Furthermore, based on a result of the detection, a suitable user interface can be provided according to a state where the imaging apparatus 100 and the information processing apparatus 200 are in use.

Moreover, according to the embodiment of the present technology, the imaging apparatus 100 in the cylindrical shape (column shape) is described as an example, but the embodiments of the present technology can apply to imaging apparatuses in other shapes that are mountable on different apparatuses. Furthermore, according to the embodiment of the present technology, the information processing apparatus 200, such as the smartphone or the tablet terminal, is described as an example, but the embodiments of the present technology can apply also to other apparatuses that can be connected to the imaging apparatus using the wireless communication.

Furthermore, according to the embodiment of the present technology, the example in which it is detected whether or not the imaging apparatus is mounted on the information processing apparatus is described, but the embodiments of the present technology can apply also to a case where one apparatus is mounted on another apparatus. For example, the embodiments of the present technology can apply to detection of whether or not a light emission apparatus that is used at the time of capturing a static image is mounted on an imaging apparatus (for example, a digital still camera). Furthermore, the embodiments of the present technology can apply to detection of whether or not a sound collection apparatus (for example, a microphone) that is used at the time of capturing a moving image is mounted on an imaging apparatus (for example, a camera-integrated recorder). Furthermore, the embodiments of the present technology can apply to detection of whether or not an audio output apparatus (for example, a speaker) that is used at the time of reproducing a moving image is mounted on an imaging apparatus (for example, a camera-integrated recorder). Moreover, in these cases, a control unit of an imaging apparatus may perform mounting determination, and a control unit of another apparatus (for example, a light emission apparatus, a sound collection apparatus, or an audio output apparatus) that is mounted on the imaging apparatus may perform the mounting determination. That is, if an apparatus performs communication with a different apparatus using short-range wireless communication, a control unit of the apparatus can determine whether or not the different apparatus is mounted, based on a result of the communication with the different apparatus using the short-range wireless communication.

Moreover, the embodiments described above are described as examples for realizing the present technology, and matters according to the embodiments have a one-to-one correspondence relationship with technology-specific matters in claims. In the same manner, the technology-specific matters in claims have a one-to-one correspondence relationship with matters according to the embodiments of the present technology, which have the same names as the technology-specific matters. However, the present technology is not limited to the embodiments, and may be realized by making various modifications to the embodiments within a range that does not deviate from the gist of the present technology.

Furthermore, the processing processes described according to the embodiments may be regarded as a method that has a sequence of the processes, may be a program for causing a computer to execute the sequence of the processes, or may be a recording medium on which the program is stored. As the recording medium, for example, a Compact Disc (CD), a MiniDisc (MD), a Digital Versatile Disc (DVD), a memory card, a Blu-ray Disc (registered trademark) and the like can be used.

Moreover, effects described in the present specification are for illustration and thus are not limited to this illustration, and other effects may be present.

Moreover, the present technology can be configured as follows.

(1) An information processing apparatus including: a wireless communication unit that performs communication between the information processing apparatus and an imaging apparatus using short-range wireless communication; and a control unit that determines whether or not the imaging apparatus is mounted, based on a result of the communication with the imaging apparatus that uses the short-range wireless communication.

(2) The information processing apparatus according to (1), in which the control unit transmits a command for polling, in which if a response to the command is received, the control unit determines that the imaging apparatus is mounted, and in which if the response to the command is not received, the control unit determines that the imaging apparatus is not mounted.

(3) The information processing apparatus according to (2), in which if the response to the command is received, the control unit transmits a check command for reading information relating to the imaging apparatus, and in which only if specific information for specifying the imaging apparatus is included in the response to the check command, the control unit determines that the imaging apparatus is mounted.

(4) The information processing apparatus according to (1), in which the wireless communication unit performs the communication between the information processing apparatus and the imaging apparatus using near field communication (NFC) as the short-range wireless communication, in which only if a polling response is received as the response to the transmitted polling command, the control unit determines that the imaging apparatus is mounted, and in which if the response to the polling command is not received, the control unit determines that the imaging apparatus is not mounted.

(5) The information processing apparatus according to (4), in which if the polling response is received, the control unit transmits a check command, and in which only if specific information for specifying the imaging apparatus is included in a check response that is received as a response to the check command, the control unit determines that the imaging apparatus is mounted.

(6) An imaging apparatus including: a wireless communication unit that performs communication with the imaging apparatus and an information processing apparatus using short-range wireless communication; and a control unit that performs control relating to an imaging operation based on an operation input that is performed in the information processing apparatus that determines whether or not the imaging apparatus is mounted on the information processing apparatus based on a result of the communication between the imaging apparatus and the information processing apparatus that uses the short-range wireless communication.

(7) The imaging apparatus according to (6), in which if a command for polling is received from the information processing apparatus, the control unit transmits a response to the command, and in which if the response to the command is received, the information processing apparatus determines that the imaging apparatus is mounted, and if the response to the command is not present, the information processing apparatus determines that the imaging apparatus is not mounted.

(8) The imaging apparatus according to (7), in which the control unit includes specific information for specifying the imaging apparatus in a response to a check command for reading information relating to the imaging apparatus and thus transmits the response, and in which if the response to the command is received, the information processing apparatus transmits the check command, and only if the specific information is included in the response to the check command, the information processing apparatus determines that the imaging apparatus is mounted.

(9) The imaging apparatus according to (6), in which the control unit transmits a polling response as a response to a polling command that is transmitted by the information processing apparatus using NFC as the short-range wireless communication, and in which if the polling response is received as the response to the polling command, the information processing apparatus determines that the imaging apparatus is mounted, and if the response to the polling command is not present, the information processing apparatus determines that the imaging apparatus is not mounted.

(10) The imaging apparatus according to (9), in which the control unit includes specific information for specifying the imaging apparatus in a check response that is a response to a check command that is transmitted by the information processing apparatus, and thus transmits the check response and in which if the polling response is received, the information processing apparatus transmits the check command, and only if the specific information is included in the check response that is received as the response to the check command, the information processing apparatus determines that the imaging apparatus is mounted.

(11) An information processing apparatus including: a wireless communication unit that performs communication between the information processing apparatus and a different information processing apparatus using short-range wireless communication; and a control unit that determines whether or not the different information processing apparatus is mounted, based on a result of the communication with the different information processing apparatus that uses the short-range wireless communication.

(12) An imaging system including: an imaging apparatus that performs communication between the imaging apparatus and an information processing apparatus using short-range wireless communication; and an information processing apparatus that determines whether or not the imaging apparatus is mounted, based on a result of the communication with the imaging apparatus that uses the short-range wireless communication.

(13) A method of controlling an information processing apparatus, including: performing communication between the information processing apparatus and an imaging apparatus using short-range wireless communication; and determining whether or not the imaging apparatus is mounted, based on a result of the communication with the imaging apparatus that uses the short-range wireless communication.

(14) A method of controlling an imaging apparatus, including: performing communication between the imaging apparatus and an information processing apparatus using short-range wireless communication; and performing control relating to an imaging operation based on an operation input that is performed in the information processing apparatus that determines whether or not the imaging apparatus is mounted on the information processing apparatus based on a result of the communication between the imaging apparatus and the information processing apparatus that uses the short-range wireless communication.

(15) A program for causing a computer to perform: communication between the computer and an imaging apparatus using short-range wireless communication; and determination of whether or not the imaging apparatus is mounted, based a result of the communication with the imaging apparatus that uses the short-range wireless communication.

(16) A program for causing a computer to perform: communication between the computer and an information processing apparatus using short-range wireless communication; and control relating to an imaging operation based on an operation input that is performed in the information processing apparatus that determines whether or not an imaging apparatus is mounted on the information processing apparatus based on a result of the communication between the imaging apparatus and the information processing apparatus that uses the short-range wireless communication.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a wireless communication unit that performs communication between the information processing apparatus and an imaging apparatus using short-range wireless communication; and
a control unit that determines whether or not the imaging apparatus is mounted, based on a result of the communication with the imaging apparatus that uses the short-range wireless communication.

2. The information processing apparatus according to claim 1,
wherein the control unit transmits a command for polling, and
wherein if a response to the command is received, the control unit determines that the imaging apparatus is mounted, and if the response to the command is not received, the control unit determines that the imaging apparatus is not mounted.

3. The information processing apparatus according to claim 2,
wherein if the response to the command is received, the control unit transmits a check command for reading information relating to the imaging apparatus, and
wherein only if specific information for specifying the imaging apparatus is included in the response to the check command, the control unit determines that the imaging apparatus is mounted.

4. The information processing apparatus according to claim 1,
wherein the wireless communication unit performs the communication between the information processing apparatus and the imaging apparatus using near field communication (NFC) as the short-range wireless communication, and
wherein only if a polling response is received as the response to the transmitted polling command, the control unit determines that the imaging apparatus is mounted, and if the response to the polling command is not received, the control unit determines that the imaging apparatus is not mounted.

5. The information processing apparatus according to claim 4,
wherein if the polling response is received, the control unit transmits a check command, and
wherein only if specific information for specifying the imaging apparatus is included in a check response that is received as a response to the check command, the control unit determines that the imaging apparatus is mounted.

6. An imaging apparatus comprising:
a wireless communication unit that performs communication with the imaging apparatus and an information processing apparatus using short-range wireless communication; and
a control unit that performs control relating to an imaging operation based on an operation input that is performed in the information processing apparatus that determines whether or not the imaging apparatus is mounted on the information processing apparatus based on a result of the communication between the imaging apparatus and the information processing apparatus that uses the short-range wireless communication.

7. The imaging apparatus according to claim 6,
wherein if a command for polling is received from the information processing apparatus, the control unit transmits a response to the command, and
wherein if the response to the command is received, the information processing apparatus determines that the imaging apparatus is mounted, and if the response to the command is not present, the information processing apparatus determines that the imaging apparatus is not mounted.

8. The imaging apparatus according to claim 7,
wherein the control unit includes specific information for specifying the imaging apparatus in a response to a check command for reading information relating to the imaging apparatus and thus transmits the response, and
wherein if the response to the command is received, the information processing apparatus transmits the check command, and only if the specific information is included in the response to the check command, the information processing apparatus determines that the imaging apparatus is mounted.

9. The imaging apparatus according to claim 6.
wherein the control unit transmits a polling response as a response to a polling command that is transmitted by the information processing apparatus using NFC as the short-range wireless communication, and
wherein if the polling response is received as the response to the polling command, the information processing apparatus determines that the imaging apparatus is mounted, and if the response to the polling command is not present, the information processing apparatus determines that the imaging apparatus is not mounted.

10. The imaging apparatus according to claim 9,
wherein the control unit includes specific information for specifying the imaging apparatus in a check response that is a response to a check command that is transmitted by the information processing apparatus and thus transmits the check response, and
wherein if the polling response is received, the information processing apparatus transmits the check command, and only if the specific information is included in the check response that is received as the response to the check command, the information processing apparatus determines that the imaging apparatus is mounted.

11. An information processing apparatus comprising:
a wireless communication unit that performs communication between the information processing apparatus and a different information processing apparatus using short-range wireless communication; and
a control unit that determines whether or not the different information processing apparatus is mounted, based on a result of the communication with the different information processing apparatus that uses the short-range wireless communication.

12. An imaging system comprising:
an imaging apparatus that performs communication between the imaging apparatus and an information processing apparatus using short-range wireless communication; and
an information processing apparatus that determines whether or not the imaging apparatus is mounted, based on a result of the communication with the imaging apparatus that uses the short-range wireless communication.

13. A method of controlling an information processing apparatus, comprising:
performing communication between the information processing apparatus and an imaging apparatus using short-range wireless communication; and
determining whether or not the imaging apparatus is mounted, based on a result of the communication with the imaging apparatus that uses the short-range wireless communication.

14. A method of controlling an imaging apparatus, comprising:
performing communication between the imaging apparatus and an information processing apparatus using short-range wireless communication; and
performing control relating to an imaging operation based on an operation input that is performed in the information processing apparatus that determines whether or not the imaging apparatus is mounted on the information processing apparatus, based on a result of the communication between the imaging apparatus and the information processing apparatus that uses the short-range wireless communication.

15. A program for causing a computer to perform:
communication between the computer and an imaging apparatus using short-range wireless communication; and
determination of whether or not the imaging apparatus is mounted, based a result of the communication with the imaging apparatus that uses the short-range wireless communication.

16. A program for causing a computer to perform:
communication between the computer and an information processing apparatus using short-range wireless communication; and
control relating to an imaging operation based on an operation input that is performed in the information processing apparatus that determines whether or not an imaging apparatus is mounted on the information processing apparatus based on a result of the communication between the imaging apparatus and the information processing apparatus that uses the short-range wireless communication.
